(19) United States
(12) Patent Application Publication
(10) Pub. No.: US 2015/0338063 A1
(43) Pub. Date: Nov. 26, 2015

(54) Photoluminescent devices suited for a broad range of applications

(71) Applicants: Mark George Buckley, Clonakilty (IE); Andy James Wills, Galmpton (GB)

(72) Inventors: Mark George Buckley, Clonakilty (IE); Andy James Wills, Galmpton (GB)

(21) Appl. No.: 14/286,438

(22) Filed: May 23, 2014

(51) Int. Cl. F21V 9/16; F21V 8/00; F21S 8/00

(52) U.S. Cl. CPC F21V 9/16; F21S 8/036; G02B 6/0006; F21W 2131/40

(57) ABSTRACT

Photoluminescent devices having photoluminescent strip which may be either single extruded or co-extruded, which can be easily, readily and safely installed practically in/with almost any structure/place (buildings, ships, modular structures, prefabs, rigs, platforms, stages, mines, tunnels, subterranean networks and structures, outdoor fields, vehicle, craft, etc) in order to provide a light source during low level lighting or darkness. The said devices can be fixed to substratum with the means such as double-sided adhesive, screw, etc.

### PRIORITY CLAIM

The present application claims benefit of priority from the UK patent application number GB1309442.0 filed on 24 May 2013, the entire content of which is incorporated herein by reference.

### FIELD OF THE INVENTION

The invention relates generally to photoluminescent devices, and more particularly to photoluminescent devices which can be easily and readily installed practically in/with almost any structure (buildings, ships, modular structures, prefabs, rigs, platforms, stages, mines, tunnels, subterranean networks and structures, outdoor pathways, vehicle, craft, etc) in order to provide a light source during low level lighting or darkness.

### BACKGROUND OF THE INVENTION

A number of photoluminescent devices are known in prior art for providing aesthetic features to a building or an ambience. Also the photoluminescent devices are known in prior art which are used for emergency exits.

None of the known devices in prior art provides a solution for installing the devices ubiquitously, easily and readily in any structure in such a way as to be inconspicuous, innocuous to a particular ambience under normal light.

There is no device in prior art which was invented with the purpose of being applied universally in everyday environments such that failsafe lighting may become an achievable and affordable goal for all and not just for commercial or public buildings where such lighting is mandatory. Such a product would, by definition, have to be inculcated seamlessly with standard décor. Good design is essential for the promulgation of safety devices in an effort to have them integrated into our everyday lives, thereby making our living and working environments safer. These safety devices can also be more; they can be habitual lighting sources and aesthetic lighting sources as well as aesthetic and architectural features in their own right. This is why the devices disclosed herein are designed to be seamlessly harmonized into practically all structures, from its ability to sit with covings, architraves and skirtings, to being included commonly in tongue and grooved structures such as floors, paneling, tiles, etc and as glazing beading for windows and doors.

Energy saving and energy optimisation are essential due to costs and availability of energy and light; and it is for this reason that photoluminescent strips, coupled with smart use of energy, will result in very low cost lighting for environments. For example, with the advent of large warehousing units and large internet server centres where vast areas are under cover but are not in habitual use, these devices will facilitate large energy savings. They are also perfect for outdoor pathway marking.

As the photoluminescence element of the devices has a long decay time (typically 8 hours), this means that by introducing light energy in short burst to the photoluminescent device such that the device has some charge in it, the device may then emanate its low energy light for a substantial time after this. The result is a low cost light source with a high degree of fail-safeness.

Light may be propagated to the photoluminescent component of the device by use of light fibre, from where light is transported along the photoluminescent device by use of attenuating (lossy strings) so as to distribute the light along the length of photoluminescent device, or by use of solar cells to capture ambient light for storage and distribution in the photoluminescent device, or by use of battery power to pulse light to the photoluminescent device and by use of electrical transformers to power light source. Where electrical energy is used to create a light source, it means we can use that light source for short amounts of time (e.g. 5 minutes) to create a long-lasting, low energy light form our photoluminescent device. This is one of the aspects which is not there in the existing photoluminescent devices known in prior art.

All the devices in prior art come with cumbersome and inflexible procedure for installation and removal. Many of the known devices require invasive fixing such as screws, clips, nuts, bolts to fix to a substratum or to a main body. Also all of the known apparatus require an inherent substratum element or/and number of assembled elements and hence are very expensive as far as material and installation costs are concerned. Invasive fixings (screws, bolts, etc) can pose serious dangers, especially in a home for hidden wires and pipes. This aspect makes them cost restrictive for most abodes and businesses.

Another major drawback of the devices in the prior art is the limitation in their universality of application. In other words, they can only be fitted in their exclusive actuality and only in certain areas, as they lack mechanical flexibility of use and usage. Also devices in prior art are limited to the surfaces and strata which they can be affixed to. Most of those conventional devices are of a fixed and determined length and structure, giving them a determined use only. Most of the devices in prior art demand extensive and elaborate preparation, tools and skills for installation. Usually these devices require special preparation of surface and a flat or homogenous surface to receive fixing.

Also all of the known devices have a potential to be inherent hazards themselves, such as trip hazards, snag hazards, and microbiological hazards. Many of the conventional devices in prior art are intrinsically unsafe for explosive atmosphere application.

None of the known devices in prior art are designed to provide aesthetic value to an ambience and not to disturb/spoil the original look of an ambience. They are non-aesthetically designed i.e., they have visual protuberances and are unsightly, and hence are unsuitable for common environments which are designed to be pleasing to the eye.

Also the known devices in prior are not suitable for environments where anti-microbial properties are essential.

Since the devices known in the prior art are fixed to substrate with bolts and other invasive materials, their reusability is minimal. Once used, their design and appearance get disturbed and distorted. In case of reuse, they are not as good as the new ones as far as look and adaptability are concerned.

It is now apparent that none of the photoluminescent devices in prior art does not have dual purpose, i.e., maintaining or/and enhancing look of ambient environment and providing light source at the same time. The manufacturing process/procedures of the known devices in the prior art are complex and time consuming. None of the conventional devices in prior art is considered for habitual use.

Accordingly, there is a need in the art to develop photoluminescent device(s) configured to overcome the drawbacks of the photoluminescent devices discussed above.

### BRIEF SUMMARY OF THE INVENTION

Accordingly, the invention provides photoluminescent devices which can be easily, readily and safely installed practically in/with almost any structure/place (buildings, ships, modular structures, prefabs, rigs, platforms, stages, mines, tunnels, subterranean networks and structures, outdoor fields, vehicle, craft, etc) in order to provide a light source during low level lighting or darkness.

The advantages of the devices disclosed and described herein as invention over devices in prior art are manifold. The devices in the invention are designed such that they may be used as an aesthetic light source as well as being a customary and habitual light source and more importantly as an emergency failsafe light source. All the devices are aesthetically designed to be inconspicuous and innocuous during ambient light, and are only noticeable in low level light or dark situations. Also they are aesthetically designed such as to be used for cosmetic and artistic reasons such as covering poor workmanship in a joint or covering over cracks, damp or discolouration. Also the devices can be packed as rolls for ease of transportation and installation/application. As they come in rolls they can be of indeterminate length. They may also be coiled. Most of the devices are designed to be easily retro-fitted.

Another advantage of the devices in the invention is where a porous surface prevents the use of the self-adhesive strip, the device(s) is/are configured so as to easily accept an appropriate mastic.

The devices disclosed are also designed to be resilient, strong and durable while still being very flexible with a degree of rigidity to give it workable substance, giving the devices the ability to be used on a range of surfaces and strata and environments, which is not possible with devices in prior art. Such features make these devices fit to be used in mines, caves, tunnels, natural and man-made subterranean structures and listed buildings.

Because of the inherent nature of the devices, they are strong enough to take screws and fixings while still maintaining its flexibility. Such feature allows it to be used in mines, caves, tunnels, natural and man-made subterranean structures and listed buildings where its self adhesive nature may be unsuitable, unnecessary, superfluous or inadequate.

A further advantage of the invention is that due to the nature of the devices they can be easily cut to produce practically any shape, allowing the negative space to be used as the indicators. The devices can be mitered with a standard scissors, contributing to its aesthetic, artistic or cosmetic application.

Another advantage is that the devices can be used in buildings where invasive fittings are forbidden or prohibitively expensive, e.g., aquaria, glass walls, walls where there may be pipes or cable hidden behind, etc.

Another major advantage of the devices is reusability. These devices are designed to be reusable. By virtue of its flexible nature and resilient constitution the devices may be pulled off from its position (say for purposes of painting the wall) and can be re-stuck by application of a mastic or adhesive.

Another major advantage of the invention is that due to the simplicity of the devices, they can be manufactured to meet atmosphere explosive ATEX regulations (94/9/EC Directive).

Another advantage of the invention is that the devices can be made antimicrobial by using chemical such as silver ion additive.

Another advantage is that by use of solar cells, micro wind and wave energy as a power source, long lighting times are available for short bursts of energy, so in effect it is creating a light storage and release system. This also allows use where conventional AC power is not available.

One of the embodiments of the Invention is the devices are photoluminescent because of the presence of chemicals/substance which have photoluminescent characteristic.

Another embodiment of the devices in the Invention is their flexibility because of which they may have multiple applications.

### BRIEF DESCRIPTION OF DRAWINGS

FIG. 1 is a head on view of the device 1 in which the extruded photoluminescent body/strip with lips is fixed or held on a surface/substratum.

FIG. 1b is a top view of the device 1 in which fixtures and a directional arrow are shown.

FIG. 2 is a head on view of the device 1 in which the extruded photoluminescent body without lips is fixed or held on a surface/substratum with the help of self-adhesive tape or/and a range of fittings.

FIG. 3 is a head on view of the device 1 in which the extruded photoluminescent body/strip with lips has a score/groove running longitudinally through it.

FIG. 3b is an isometric view of the device 1 in FIG. 3 when folded out.

FIG. 3c is a side view of the device 1 in FIG. 3 when folded in.

FIG. 4 is a head on view of the device 1 in which the extruded photoluminescent body/strip without lips has a score/groove running longitudinally through it.

FIG. 5 is a cross-sectional view of the co-extruded device 1A wherein concave back in between the device 1A and the surfaces of the substratum is shown.

FIG. 5a is an isometric view of the co-extruded device 1A of FIG. 5 wherein the concave back in between the device 1A and the surfaces of the substratum is shown.

FIG. 6 is a cross-sectional view of a co-extruded device 1A in the Cavetto shape without concave back and lips.

FIG. 6b is a head on view of single-extruded photoluminescent device in the Cavetto shape.

FIG. 7 is a head on view of a co-extruded photoluminescent device 1A in the Ovolo shape with concave back running longitudinally along at the back.

FIG. 8 is an isometric view of a flat photoluminescent strip in FIG. 1 showing the lips as a feature of the photoluminescent extrusion.

FIG. 9 is a top view looking directly upon the photoluminescent strip (in FIG. 1) face cut in a manner/fashion so as to provide contrast in a low level light situation.

FIG. 10 is top view looking directly upon the photoluminescent device in typical use, wherein the flat strip is cut to create an arrow shape for use to highlight an exit in a low level light situation.

FIG. 11 shows the photoluminescent device in typical use where an electric light switch is surrounded in an aesthetic fashion by the mitered coving.

FIG. 12 shows a coving (device 1A as shown in FIG. 5) in use.

FIG. 13 demonstrates devices in FIG. 3 and FIG. 4 in a typical use.

FIG. 14 demonstrates application of devices in the invention as a habitual light source where a person walks at night from his bed to a lavatory.

FIG. 15 demonstrates application of the devices in invention as an architectural aesthetic aid in a glass or/and steel structure environment.

FIG. 16 is an isometric view of tongue and grooved floor boards.

FIG. 16b is an end view and a perspective view of an expansion joint or tongue and groove insert device

FIG. 17 is a facing view of a door with glass and glazing beading showing.

FIG. 18 is a side view of a lossy (attenuating) light carrying fibre.

FIG. 18b is an isometric view of a lossy (attenuating) light carrying fibre.

FIG. 18c is an end view of the lossy (attenuating) light carrying fibre.

FIG. 19 is an illustration of how solar cell and battery arrangement produces electricity to create a light source which illuminates the lossy (attenuating) fibre in the photoluminescent strip.

FIG. 20 shows a transformer used to power a light source which illuminates the lossy (attenuating) fibre running longitudinally in the photoluminescent strip.

FIG. 21 is a transformer connected to a current and in turn connected to a light string which runs longitudinally through the photoluminescent strip.

### DETAILED DESCRIPTION OF THE INVENTION

Referring to the FIG. 1, there is shown a head on view of an elongated extruded photoluminescent device 1 with lips 2 at longitudinal edges pressing against the substratum 4 which can be a wall or floor of a building or which may be any even solid flat surface. Lips 2 is an important aspect of the device 1. This lip is an important aspect of the device 1 and has at least 5 purposes: a) it protects the adhesive from cleaning agents and the environment, b) it prevents the product from being a trip hazard when on the floor or a snag hazard, c) it reduces ability for micro biota, flora, fauna and dust to nestle in or on product, therefore making it cleaner and pro-active in its cleanliness, d) the exterior visible curve of the lips presents a homogenous finish to the strip which diffuses light and is a significant contribution to its aesthetic finish, e) it is easy to clean (this is important as washability is a criteria used in many regulations for safety lighting e.g., New York Building Safety Code 6-1). A thin double-sided adhesive tape 3 is employed to fix or attach the photoluminescent device 1 to substratum 4. Other means such as glue or mastic or bolt or screw or U-pin or combination of the said means for fixing or attaching the strip to substratum like wall or floor of a building. In one embodiment, the device contains a photoluminescent capability due to presence of photoluminescent chemical pigments known in prior art for providing a light source in a low level light environment. This photoluminescent capability is an important aspect in all devices disclosed in this Invention. The device 1 can be made antimicrobial by using chemical such as silver ion additive. The devices may be used as a temporary rope type light without being attached to anything for the sake of marking a path or area, and rolled up again after use. The device 1 may be stuck back-to-back on an identical length of itself such that it forms a photoluminescent strap or rope.

Referring to FIG. 1b, there is shown a top view of the elongated extruded photoluminescent device 1 with a printed arrow 12 for directional purposes and the light diffusing edge of the upper part of the lips 15. The head of a screw 5, bolt 51 and u-pin 52 are shown as possible manners of fixing the photoluminescent device 1 to different types of sub-strata.

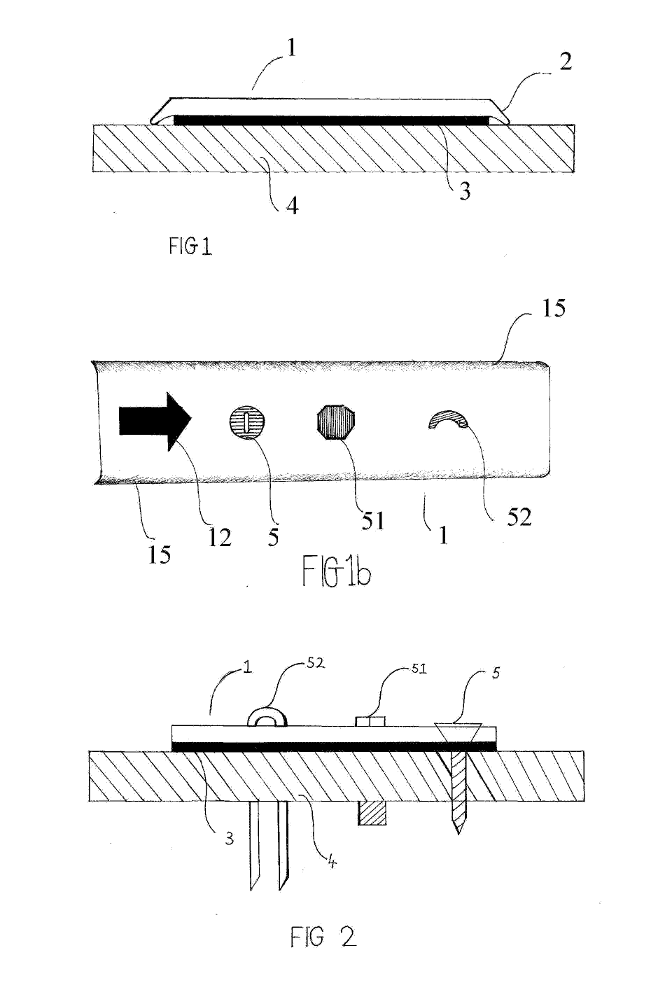

Referring to the FIG. 2, there is shown a head on view of an elongated extruded photoluminescent device 1 without lips. A thin double-sided adhesive tape 3 is employed to fix or attach the photoluminescent device 1 to substratum 4. A screw 5, bolt 51 and u-pin 52 are shown as possible manners of fixing the photoluminescent device 1 to different types of sub-strata.

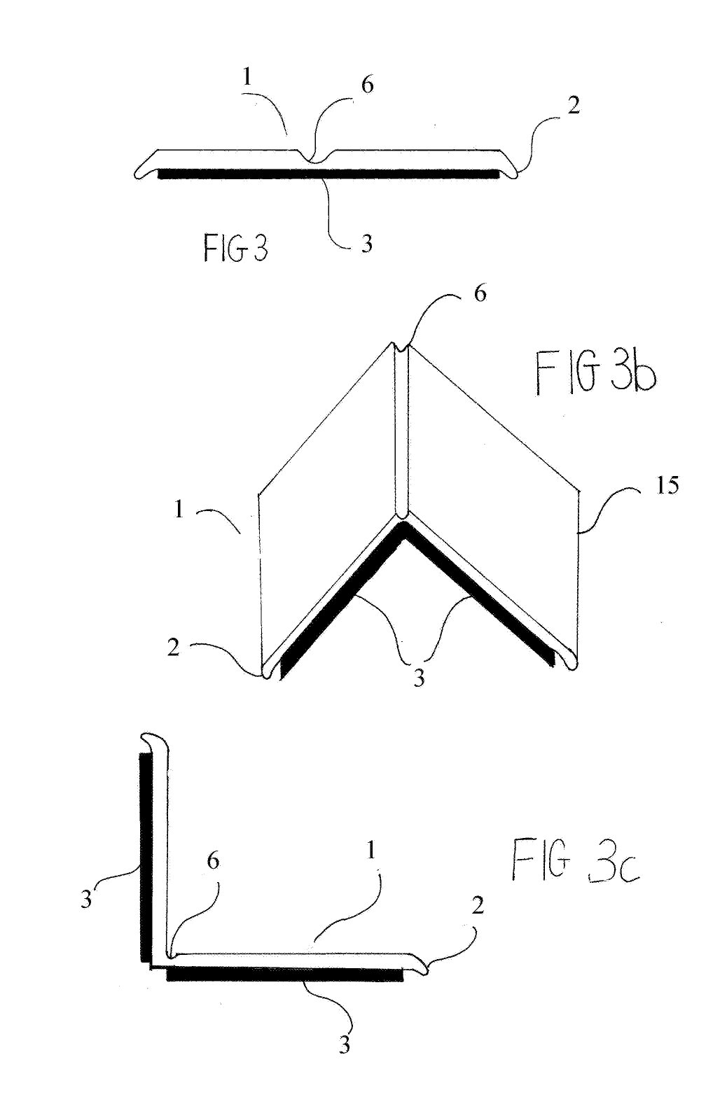

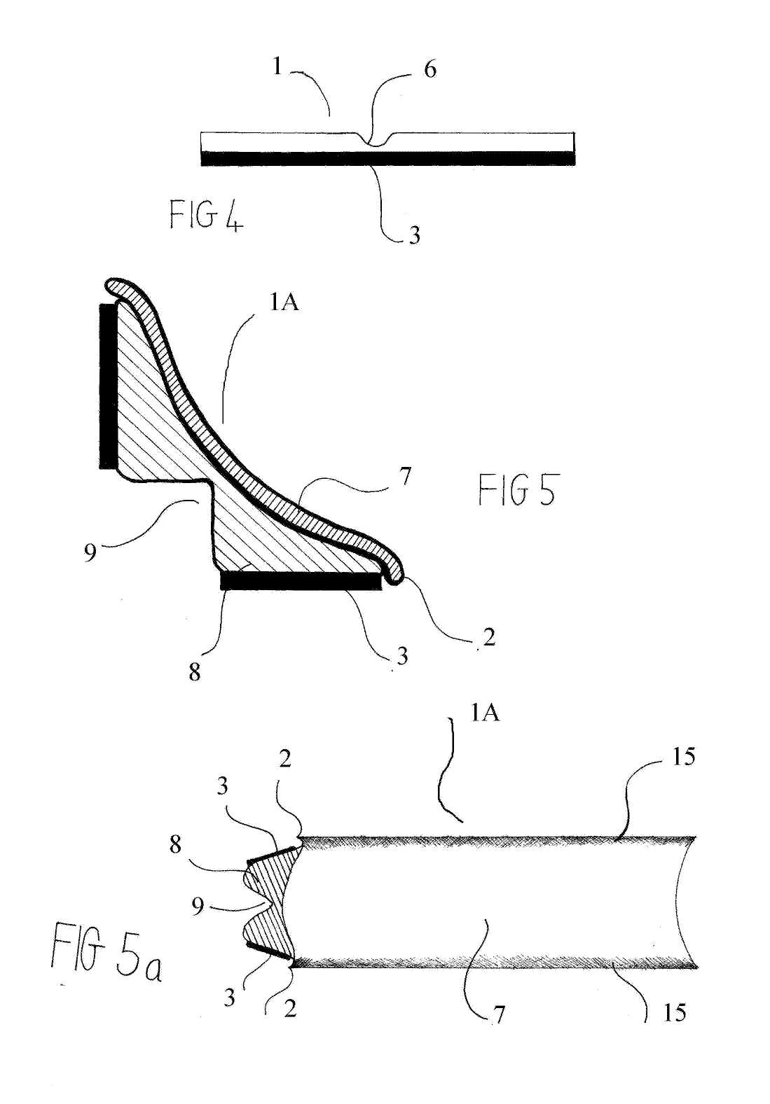

Referring to the FIG. 3, there is shown head on view of an elongated extruded photoluminescent device 1 with lips 2 at longitudinal edges and a score/groove 6 running longitudinally through it. This score 6 is an additional aspect to the device 1 shown in FIG. 1. A thin double-sided adhesive tape 3 is employed to fix or attach the photoluminescent device 1 to substratum. The elongated extruded photoluminescent strip of the device 1 with score 6 can be made concave within/inside to facilitate accurate folding of the same. The presence of score 6 running longitudinally as an axis of the photoluminescent strip facilitates accurate folding without distortion of the photoluminescent strip. The flat photoluminescent strip of device 1 with score 6 running lengthwise gives the device 1 the ability to fold easily and precisely, so that it may be applied to corners and curves including spatial curves. Such strip is designed practically to fit onto any 2 plane corner with an angle lying between 10 and 350 degrees. And also such score facilitates the folding of the plastic without distortion, as without the score the memory of the plastic would either pull or push the resultant folded shape back to its original flat self. This photoluminescent strip, with score 6, may be without lips as shown in FIG. 4.

Referring to FIG. 3b, there is shown an isometric view of an elongated extruded photoluminescent device (shown in FIG. 3) folded away from the score 6 with a thin double-sided adhesive tape 3 employed to fix or attach the photoluminescent device 1 and the light diffusing edge of the upper part of the lips 15. FIG. 3c is a side view an elongated extruded photoluminescent device (shown in FIG. 3) folded back on the score 6 and with a thin double-sided adhesive tape 3 showing with the lips 2 standing proud of the tape 3.

Referring to FIG. 5, there is shown a cross-sectional view of photoluminescent device 1A wherein a co-extruded photoluminescent strip 7 is on the top of extruded non-photoluminescent substrata 8. The device 1A can be fixed or attached to main substrata with double-sided adhesive tape 3. Fixing means such as glue can be used. The co-extruded photoluminescent strip 7 may or may not have lips 2 at longitudinal edges pressing against the main substrata such as wall or floor of a building. A concave back 9 is created between the extruded non-photoluminescent substrata 8 and corner of two walls (main substrata) for passage of cable underneath it and to allow a certain amount of flexibility along its axis or/and application of mastic. In a preferred embodiment, the two sides of non-extruded substrata, which are supposed to engaged with main substrata during use, are perpendicular to each other. The concave back 9, which is an important aspect of the device 1A, can be of any shape or design. The device 1A with the hollow back may be flexed along its axis to allow it be fixed to corners which are not exactly at 90 degrees. In an alternative embodiment, the photoluminescent strip 7 may not have continuous or/and regular photoluminescent feature.

Referring to FIG. 5a, there is shown an isometric view of the device 1A. The top part of the device 1A which will be exposed when used may be convex or concave or plane or any design. The lips 2 can be seen to stand proud of the self adhesive tape 3 and thereby press against the main substrata. The upper part of the lips 15 diffuse light by virtue of their roundness.

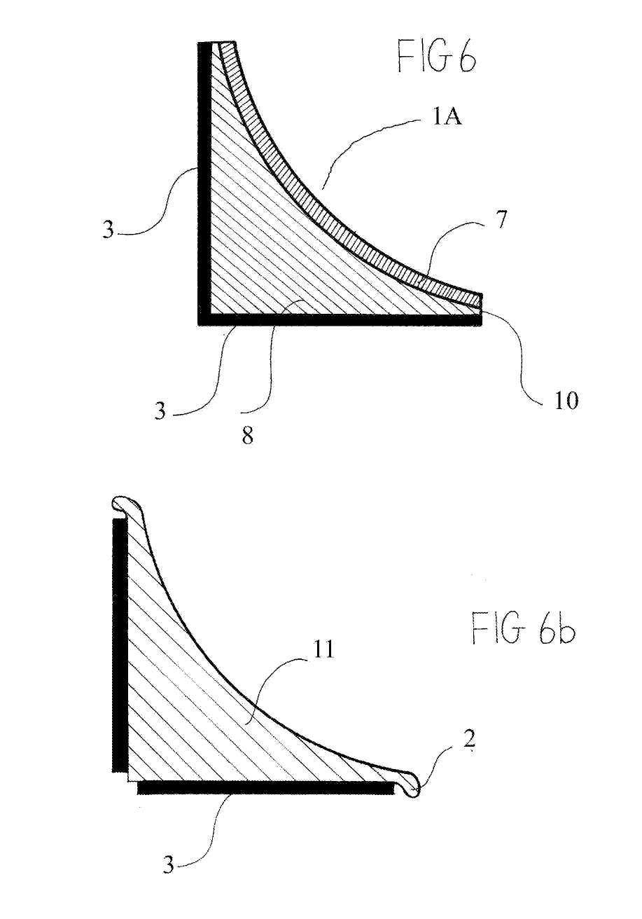

Referring to FIG. 6, there is shown a cross-sectional view of a co-extruded device 1A in the Cavetto shape without concave back (full bodied) and lips. The photoluminescent strip 7 is on the top of non-photoluminescent extruded substrata 8. The device 1A can be fixed or attached to main substrata with double-sided adhesive tape 3. This device 1A may be easily fitted and installed without any specialized knowledge, training or tools. Anyone can fit them without need of nuts, bolts, screws or other fixing agents.

Referring to FIG. 6b, there is shown a pigment carrying single extruded photoluminescent strip 11 in Cavetto shape wherein there are lips 2 and double-sided adhesive tape 3. As alternative embodiments, the single extruded photoluminescent strip 11 may have concave back and be without lips. In a preferred embodiment, the two sides of the strip which are supposed to engaged with main substrata during use, are perpendicular to each other. The top part of the device, which will be exposed when used, may be convex or concave or plane or cyma or any design.

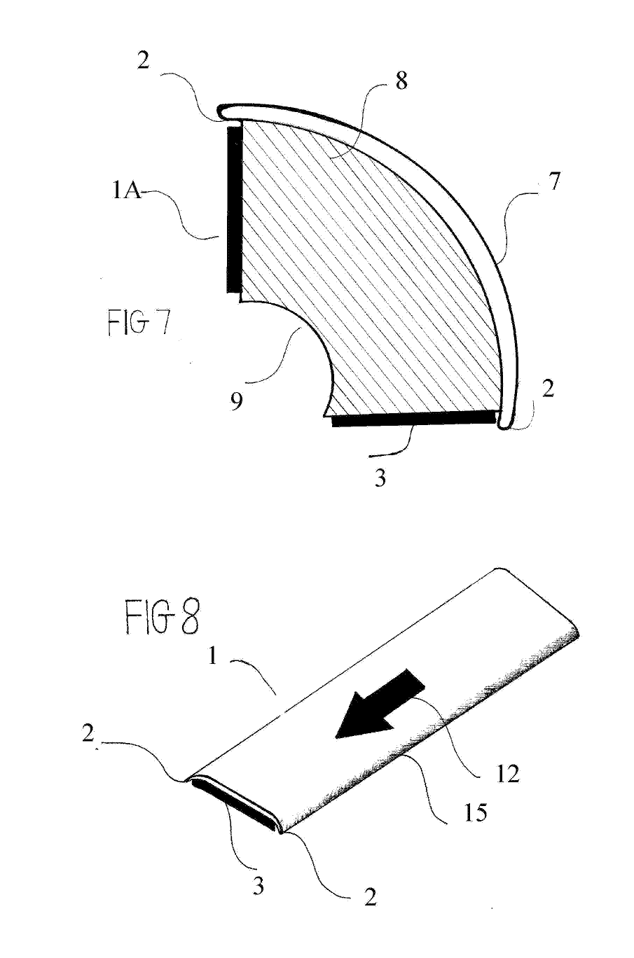

Referring to FIG. 7, there is shown a head on view of a co-extruded photoluminescent device 1A in the Ovolo shape with concave back running longitudinally along at the back. This device 1A can be fixed or attached to main substrata with double-sided adhesive 3. The lips 2 can be seen to stand proud of the self adhesive tape 3 and thereby press against the main substrata. A concave hemisphere-shaped back 9 is created between the extruded non-photoluminescent substrata 8 and corner of two walls (main substrata) for passage of cable or wires underneath it and to allow a certain amount of flexibility along its axis as well as facilitating the application of a mastic. This lip is manufactured such that it lies/touches or presses against the surface to which the devices in invention is adhering to. The lip's function is to protect the adhesive, prevent the product from being a trip or snag hazard, reduce the ability for micro biota, flora, fauna and dust to nestle in or on the product, thereby making it cleaner and pro-active in its cleanliness, make the exterior visible curve of the lips present a homogenous finish to the strip which is a significant contribution to its aesthetic finish and also make it easy to clean. The device 1A is flexible and can be rolled, making it more economical to store, transport & distribute as well as easier to apply.

Referring to FIG. 8, there is shown an isometric view of the device 1 with lips 2 as a feature of the photoluminescent extrusion. The curve of the body 15 which is necessary to create the lips 2 demonstrates the light diffusion which occurs on the outer edges. Symbol or text 12 may be used as an indicator of direction or a command.

Referring to FIG. 9, there is shown a top view looking directly at the photoluminescent device 1 which is cut to two reciprocal moieties 14 to introduce a break/space 13 which acts as contrast in a low level light situation. The said photoluminescent strips are attached to the main substratum 4 such as wall of any building with double-sided adhesive tape 3.

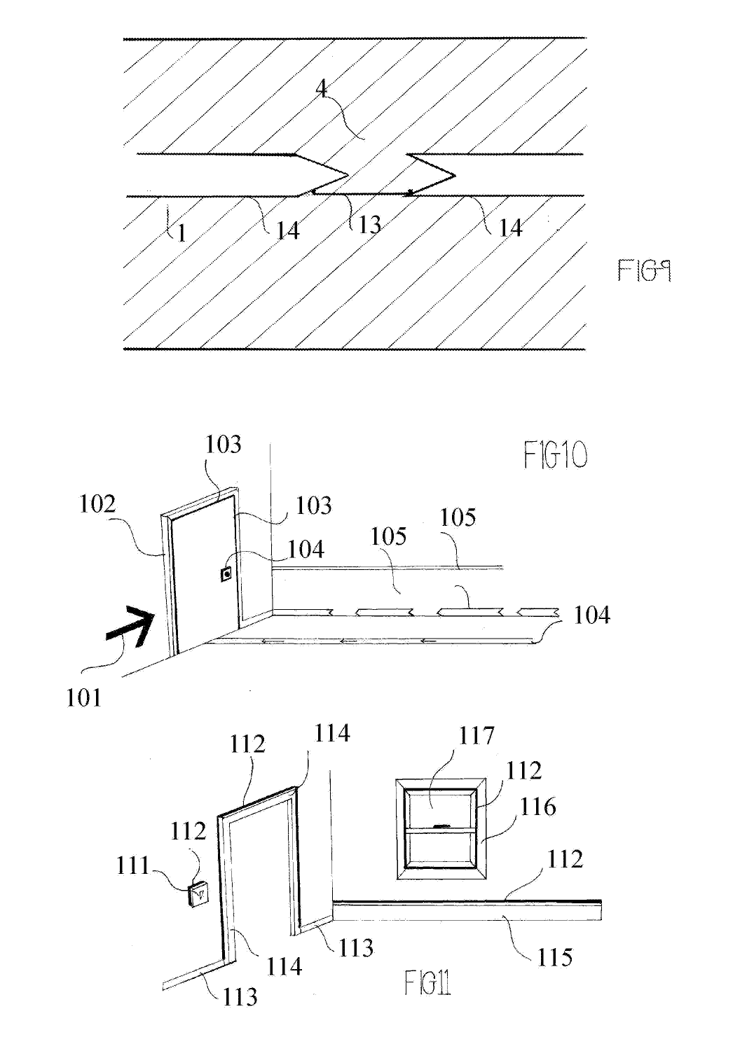

Referring to FIG. 10, there is shown a practical application of photoluminescent device 1 which is cut at three points to produce the strip 104 as shown in FIG. 9 when mounted on a wall 105. An arrow shape 101 is also shown as a construction of three pieces of photoluminescent device 1 and the aesthetic properties of the extruded photoluminescent coving 102 is demonstrated sitting against the architrave 103 of the doorway. The extruded photoluminescent device 1 is also employed to create a mitered decorative highlighting shape 104 around the door handle. The extruded photoluminescent strip 104 is also seen a wall mounting and as a floor mounting.

Referring to FIG. 11, there is shown a practical application wherein electric lights switch 111 surrounded in an aesthetic fashion by the mitered coving 112 constructed from photoluminescent strip 1A. This coving 112, constructed from strip 122, is also shown against a typical doorway architrave 114. The strip 113 is shown running along the wall close to the floor. The strip 112 is shown running along the top of a typical skirting board 115 and also in the corner of a window recess 116 where it sits against the edge of the 117 window's frame. This window is used as an escape route.

Referring to FIG. 12, there is shown a device 1A (coving 122) in use, sitting flush against a wall 124 and on top of a skirting board 121. The space created by the groove 123 in the interior of the coving shows a telephone/fibre optic cable running beneath it and where a mastic may be applied if necessary. The miter joint 125 in the corner shows the ease with which the device 1A can be aesthetically employed.

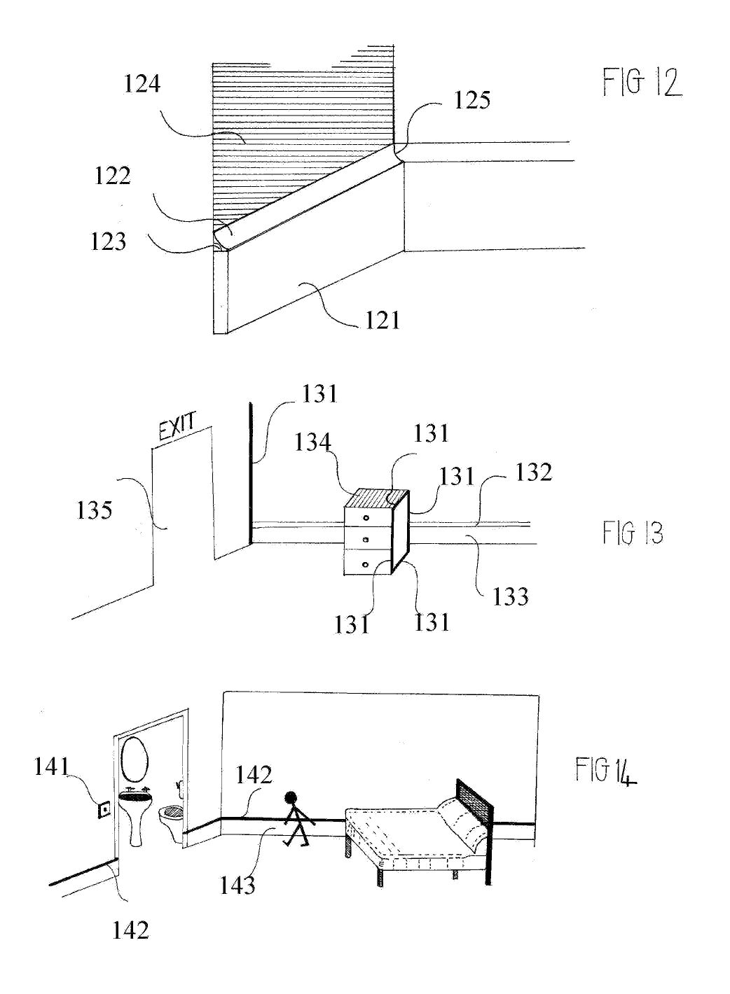

FIG. 13 demonstrates devices in FIG. 3 and FIG. 4 in a typical use. A cabinet 134 lies in an escape pathway to an exit 135 and so is marked with 131 folded outwardly along the outer edge of the 131 cabinet. 131 is also shown folded inwardly so as to fit in the corner of the wall. On top of an architectural border 133 is the device 1A of the invention.

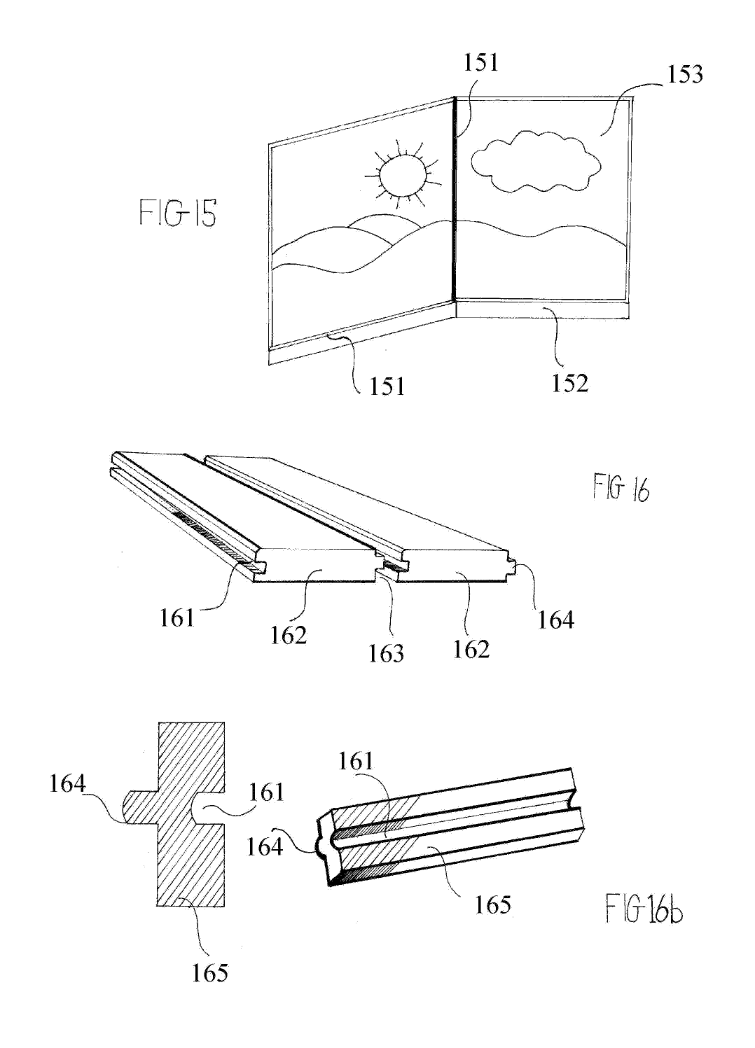

FIG. 14 demonstrates the use of devices 1 and 1A as an habitual light source where a person walks at night from his bed to a lavatory. The photoluminescent device 1A laying on top of a skirting 143 provides ample ambient light for the person to walk safely to his destination and if he so desires, an device 1 of the invention highlights the electric light switch for the lavatory.

FIG. 15 demonstrates application of devices in invention as an architectural aesthetic aid where a glass and steel structure use device 1 or 1A to create an aesthetic/cosmetic trim between the 153 glass and 152 steel base. The photoluminescent devices serves the further purpose in low level light conditions by highlighting the styling of the structure as well as being an aesthetic/cosmetic feature and may also possibly be an habitual light source and a safety lighting feature.

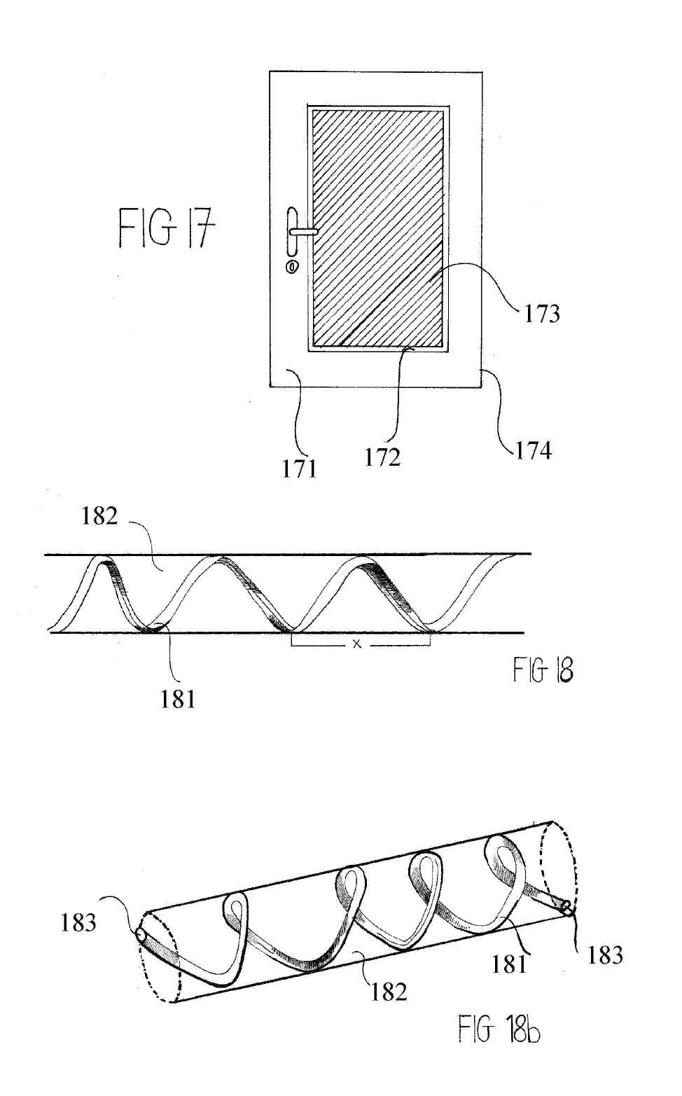

FIGS. 16 & 16b demonstrate how a photoluminescent strip may be shaped to form an expansion or insertion joint the typical arrangement for a tongue 164 and groove 161 of flooring timbers 162. The extruded photoluminescent device 165 fits into gap 163. This device can be made to integrate into tongue and groove constructions, thereby allowing failsafe lighting to become part of the construction process without interfering in the process itself. The device may act as an expansion joint in tongue and groove flooring. This device may be made from a plastic that will compress or expand with surrounding pressure. The joint of the devices in FIGS. 16 and 16b are configured for use with a floor, decking, wall, ceiling or any paneling having tongue and groove joints.

FIG. 17 shows a door 174, having a frame 171 and glass 173. The frame 171 includes a glazing beading 172 of photoluminescent material to provide an enhanced appearance and with the inbuilt photoluminescent light source, they now acts as highlighted safety exits. In other embodiments a window can have luminous beading or gaskets. There may be rods inserted in-between the layers of glass in a decorative format to act as a safety sign for egress.

Referring to FIG. 18, there is shown a side view of a lossy (attenuating) light carrying fibre, comprising the carrying fibre 182 (made of plastic) with a helically wound fibre 181 (made of plastic) embedded into it. Helically wound fibre 181 and carrying fibre 182 have different refractive indices. X is the distance along carrying fibre 182 of one complete wind of helically wound fibre 181. By manipulating the diameter (r1 in FIG. 18c) and frequency (x in FIG. 18) of the smaller fibre in the lossy string, rates and lengths of attenuation can be varied to suit the environment.

Referring to FIG. 18b, there is shown an isometric view of a lossy (attenuating) light carrying fibre, comprised of the carrying fibre 182 (made of plastic) with a helically wound fibre 181 (made of plastic) embedded into it. 183 is simply the end view of the termination of 181.

Referring to FIG. 18c, there is shown an end view of the lossy (attenuating) light carrying fibre. Where r1 is the radius of the embedded fibre and r2 is the radius of the carrying fibre and r2>r1.

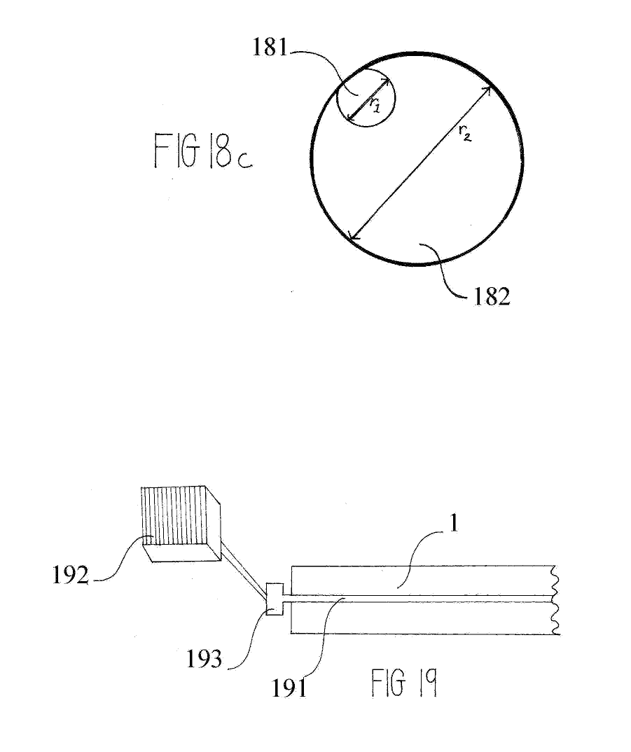

Referring to FIG. 19, there is shown a solar cell and battery arrangement 192 which produces and stores electricity to create a light source 193 which illuminates the lossy (attenuating) fibre 191 in the photoluminescent device 1 and other devices disclosed in the invention herein. In a further embodiment of the invention, the devices are designed to be manufactured using anti-microbial plastics so that they can be used in environments where anti-microbial traits are essential or desired.

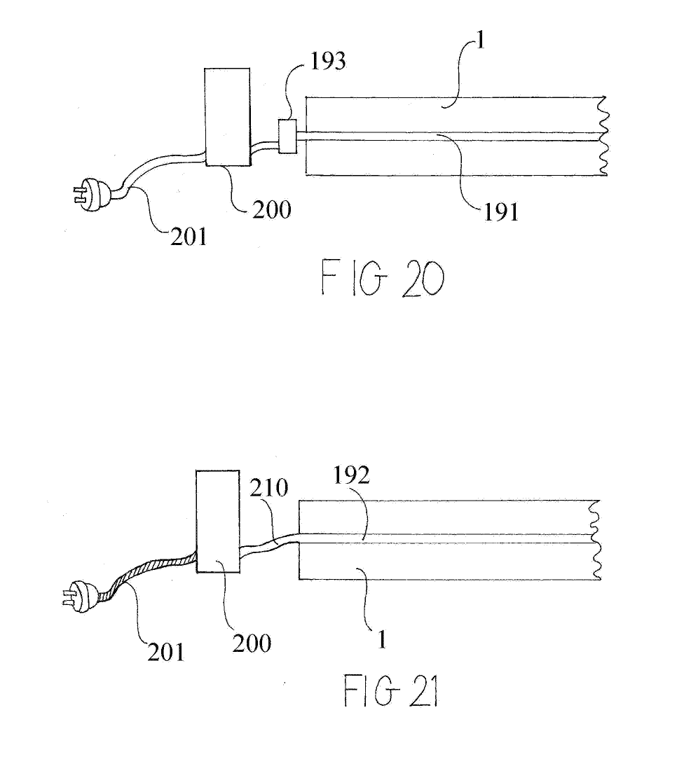

Referring to FIG. 20, there is shown a transformer 200 connected by wire 201. The current from the transformer 200 is used to power a light source 193 which illuminates the lossy (attenuating) fibre 191 running longitudinally in the photoluminescent device 1 and other devices disclosed in the invention herein.

Referring to FIG. 21, there is shown a transformer 200 connected by 201 to a current and in turn connected by wire 210 to a light string 192 which runs longitudinally through the photoluminescent device 1 and other devices. The lossy string light may be transported and attenuated in areas where no power or light source exists.

All the devices in the Invention can be made antimicrobial by using chemical such as silver ion additive.

The photoluminescent aspect of the devices disclosed herein the Invention may have a light attenuating string running along its length. The power source of the devices may be a fibre optic cable bringing light to the distal end of the attenuation string.

The fixing means for the devices disclosed in the Invention may be double-sided adhesive tape or glue or mastic or bolt or screw or U-pin or combination of any of the above.

1. A photoluminescent device having an extruded photoluminescent strip with or without lips running longitudinally along outer edges of the photoluminescent strip.

2. A photoluminescent device as claimed in claim 1, wherein the photoluminescent strip is either rigid or flexible.

3. A photoluminescent device as claimed in claim 1, wherein the photoluminescent strip has flat back surface for engagement with substratum with the help of a fixing means.

4. A photoluminescent device as claimed in claim 1, wherein the photoluminescent strip has antimicrobial feature.

5. A photoluminescent device as claimed in claim 1, wherein the photoluminescent strip has light attenuating string or fibre along its length.

6. A photoluminescent device as claimed in claims 1 and 5, wherein a fibre optic cable is employed for bringing light from a power source to the attenuating string or fibre.

7. A photoluminescent device having an extruded photoluminescent strip having a score running longitudinally in the middle of it.

8. A photoluminescent device as claimed in claim 7, wherein the photoluminescent strip is flexible.

9. A photoluminescent device as claimed in claim 7, wherein the photoluminescent strip has flat back surface for engagement with substratum with the help of fixing means.

10. A photoluminescent device as claimed in claim 7, wherein the photoluminescent strip may be with or without lips running longitudinally along outer edges of the photoluminescent strip.

11. A photoluminescent device as claimed in claim 7, wherein the photoluminescent strip has antimicrobial feature.

12. A photoluminescent device as claimed in claim 7, wherein the photoluminescent strip has light attenuating string or fibre along its length.

13. A photoluminescent device as claimed in claims 7 and 12, wherein a fibre optic cable is employed for bringing light from a power source to the attenuating string or fibre.

14. A photoluminescent device having three sided strip comprising:
a) a co-extruded photoluminescent layer on the top of one of the three sides which is above extruded non-photoluminescent substrata;
b) two other sides which are perpendicular to each other, and are meant to face and engage with two surfaces of a building/structure which are perpendicular to each other.

15. A photoluminescent device as claimed in claim 14, wherein the photoluminescent device is flexible and can be manufactured as decorative architrave in a roll format.

16. A photoluminescent device as claimed in claim 14, wherein the side with co-extruded photoluminescent layer on it may be of any shape or design such as concave, convex, or plane.

17. A photoluminescent device as claimed in claim 14, wherein the photoluminescent device may have a space of any shape or design at the corner where two sides of the non-photoluminescent substrata meet behind the photoluminescent layer.

18. A photoluminescent device as claimed in claim 14, wherein the two surfaces of the non-photoluminescent substrata which are supposed to face and engage with surfaces of a building/structure are flat.

19. A photoluminescent device as claimed in claim 14, wherein the co-extruded photoluminescent layer may be with or without lips running longitudinally along outer edges of the co-extruded photoluminescent layer.

20. A photoluminescent device as claimed in claim 14, wherein the photoluminescent device has antimicrobial feature.

21. A photoluminescent device as claimed in claim 14, wherein the co-extruded photoluminescent layer has light attenuating string or fibre along its length.

22. A photoluminescent device as claimed in claims 14 and 21, wherein a fibre optic cable is employed for bringing light from a power source to the attenuating string or fibre.

23. A photoluminescent device having three sided strip comprising a single extruded photoluminescent strip and fixing means such as double-sided adhesive tape or glue for fixing the strip to a corner of a building/structure having two surfaces perpendicular to each other.

24. A photoluminescent device as claimed in claim 23, wherein the two other sides of the strip, which are meant to face and engage with two surfaces of a building/structure, are flat and generally perpendicular to each other.

25. A photoluminescent device as claimed in claim 23, wherein the photoluminescent device is flexible and can be manufactured as decorative architrave in a roll format.

26. A photoluminescent device as claimed in claim 23, wherein the side, which is supposed to face outward during use, may be of any shape or design such as concave, convex, or plane.

27. A photoluminescent device as claimed in claim 23, wherein the photoluminescent device may have a space of any shape or design at the corner where two generally perpendicular sides of the single extruded strip meet.

28. A photoluminescent device as claimed in claim 23, wherein the single extruded photoluminescent strip may be with or without lips running longitudinally along outer edges of the side which is supposed to face outward during use.

29. A photoluminescent device as claimed in claim 23, wherein the photoluminescent device has antimicrobial feature.

30. A photoluminescent device as claimed in claim 23, wherein the single extruded photoluminescent strip has light attenuating string or fibre along its length.

31. A photoluminescent device as claimed in claim 23, wherein a fibre optic cable is employed for bringing light from a power source to the attenuating string or fibre.

32. Photoluminescent devices as claimed in claims 1, 7, 14 and 23, wherein the fixing or attaching means for attaching and fixing the devices to substratum like wall or floor of a building are double-sided adhesive tape or glue or mastic or bolt or screw or U-pin or combination of the said means.

33. An extruded photoluminescent strip having a groove and tongue running longitudinally in the middle of the strip but opposite to each other, and which can be embedded in a tongue and groove flooring or paneling.

34. Photoluminescent devices as claimed in claims 1, 7, 14 and 23, 33, wherein the devices are of any colour and are manufactured to imbed aesthetically in their environment when utilized.

35. A light carrying fibre comprising two clear plastics, where one plastic is embedded in the other in a spiral fashion, such that when a light source is placed at its distal end, the frequency and relevant thickness of the embedded plastic coupled with the refractive indices of the two materials cause regular dissipation of light along its length.
